(19) United States
(12) Patent Application Publication
(10) Pub. No.: US 2026/0143077 A1
(43) Pub. Date: May 21, 2026

(54) IMAGE READING APPARATUS AND RECORDING APPARATUS

(71) Applicant: SEIKO EPSON CORPORATION, TOKYO (JP)

(72) Inventors: Kohei KOZAKI, SHIOJIRI-SHI (JP); Kensuke TAMAI, SHIOJIRI-SHI (JP); Yoshiyuki OKAZAWA, SHIOJIRI-SHI (JP)

(21) Appl. No.: 19/387,725

(22) Filed: Nov. 13, 2025

(30) Foreign Application Priority Data
Nov. 15, 2024 (JP) 2024-199469

(51) Int. Cl. H04N 1/03; B41J 2/165; B41J 3/44; B41J 13/03; B41J 13/10; B41J 25/00; B41J 29/02; B41J 29/13; H04N 1/10

(52) U.S. Cl. CPC H04N 1/03; B41J 2/16508; B41J 3/44; B41J 13/03; B41J 13/103; B41J 25/005; B41J 29/02; B41J 29/13; H04N 1/1061; H04N 2201/0049; H04N 2201/0094

(57) ABSTRACT

An image reading apparatus includes a reading section, an FFC in which a turn-around region is formed between the first holding region and the second holding region, and a drive unit. The first holding region, the second holding region, and the FFC are located at a first direction side of the first belt section from a viewpoint of the first axis, the turn-around region of the FFC is the closest to the reading section when the reading section is located at an end portion in a third direction in a movement area, the FFC and the drive unit overlap when viewed from a normal direction when the reading section is located at the end portion in the third direction in the movement area, and the overlapping is eliminated by the reading section moving in a fourth direction from the end portion in the third direction in the movement area.

The present application is based on, and claims priority from JP Application Serial Number 2024-199469, filed Nov. 15, 2024, the disclosure of which is hereby incorporated by reference herein in its entirety.

### BACKGROUND

### 1. Technical Field

The present disclosure relates to an image reading apparatus that reads an image of a document. Further, the present disclosure relates to a recording apparatus that performs recording on a medium.

### 2. Related Art

As a recording apparatus typified by an inkjet printer, there is a recording apparatus having both a printer unit and a scanner unit as disclosed in JP-A-2018-019332. The scanner unit disclosed in JP-A-2018-019332 is of a flat-bed type and includes a platen glass and a sensor unit that moves in parallel to the platen glass. A first driven pulley and a second driven pulley are disposed at both end portions in the scanning direction of the sensor unit, and a driving pulley and a third driven pulley are disposed between the first driven pulley and the second driven pulley in the scanning direction. A belt is wound around the pulleys described above. The sensor unit is fixed to the belt.

A flexible flat cable is coupled to the sensor unit. The flexible flat cable moves with a movement of the sensor unit. A motor holder is disposed below a movement area of the flexible flat cable, and a motor, the driving pulley, and the third driven pulley are disposed in the motor holder. The motor holder is covered with a motor cover. The motor holder is covered with a motor cover in order to prevent the flexible flat cable that moves together with the sensor unit from coming into contact with a drive unit including the motor and the driving pulley. That is, the flexible flat cable and the drive unit need to be set largely apart from each other in a vertical direction in order to avoid the contact.

JP-A-2018-019332 is an example of the related art.

As described above, the flexible flat cable and the drive unit need to be set largely apart from each other in the vertical direction in order to avoid the contact, which incurs an increase in the dimension in the height direction of the apparatus.

### SUMMARY

An image reading apparatus according to the present disclosure for solving the problem described above includes a platen on which a document is placed, a reading section that has a shape extending along a first axis and is configured to read the document placed at the platen by moving along a second axis crossing the first axis, a drive unit including a motor that is a power source for moving the reading section and a driving pulley driven by the motor, a plurality of driven pulleys configured to be driven to rotate, an endless belt wound around the driving pulley and the plurality of driven pulleys and configured to pull the reading section in accordance with rotation of the motor, a case configured to constitute a base body of the apparatus and including a housing recess configured to house the drive unit, and a flexible flat cable curved to form a turn-around region between a first holding region provided to the case and a second holding region provided to the reading section, wherein the plurality of driven pulleys includes a first driven pulley, a second driven pulley, and a third driven pulley, a straight line connecting a center of a rotary shaft of the first driven pulley and a center of a rotary shaft of the second driven pulley extends along the first axis, one direction of directions along the first axis is defined as a first direction, an opposite direction to the first direction is defined as a second direction, one direction of directions along the second axis is defined as a third direction, an opposite direction to the third direction is defined as a fourth direction, the second driven pulley is located at the third direction side with respect to the first driven pulley from a viewpoint of the second axis, the third driven pulley is located at the first direction side with respect to the second driven pulley from a viewpoint of the first axis and is located at the fourth direction side with respect to the second driven pulley from the viewpoint of the second axis, and the drive unit is located at the first direction side with respect to the third driven pulley from the viewpoint of the first axis, the driving pulley is located at the fourth direction side with respect to the second driven pulley from the viewpoint of the second axis, at least a part of the drive unit is located at a position overlapping the reading section when viewed from a normal direction with respect to the platen when the reading section is located at an end portion in the third direction in a movement area, a section of the endless belt between the first driven pulley and the third driven pulley is defined as a first belt section, the first holding region, the second holding region, and the flexible flat cable are located at the first direction side with respect to the first belt section from the viewpoint of the first axis, and the turn-around region of the flexible flat cable is closest to the reading section when the reading section is located at an end portion in the third direction in the movement area, and the flexible flat cable and the drive unit overlap each other when viewed from the normal direction when the reading section is located in the end portion in the third direction in the movement area, and the overlap between the flexible flat cable and the drive unit is eliminated by the reading section moving in the fourth direction from the end portion in the third direction in the movement area.

Further, a recording apparatus according to the present disclosure includes a recording unit including a recording section configured to perform recording on a medium, and the image reading apparatus described above that is rotatably coupled to the recording unit and rotates to thereby be switchable between a closed state in which an upper portion of the recording unit is covered and an open state in which the upper portion of the recording unit is opened.

### BRIEF DESCRIPTION OF THE DRAWINGS

FIG. 1 is an exterior perspective view of a printer.

FIG. 2 is an exterior perspective view of the printer with a document cover opened.

FIG. 3 is an exterior perspective view of the printer with a scanner unit opened.

FIG. 4 is an exterior view of the printer in a state in which a medium catch tray is pulled out and a medium support is opened.

FIG. 5 is a perspective view of a recording unit with a housing removed.

FIG. 6A is a plan view of the recording unit with the housing removed.

FIG. 6B is a diagram showing a positional relationship between some elements extracted from FIG. 6A.

FIG. 7 is a diagram showing a medium conveyance path in the recording unit.

FIG. 8 is a cross-sectional view of an essential part of the printer.

FIG. 9 is a plan view of an inside of the scanner unit.

FIG. 10 is a perspective view of the scanner unit viewed from below.

FIG. 11 is a perspective view of a drive unit.

FIG. 12 is a perspective view of the drive unit.

FIG. 13 is a perspective view of a reading section and the drive unit located in an end portion in a −X direction.

FIG. 14 is a perspective view of the printer unit, the drive unit, and an endless belt.

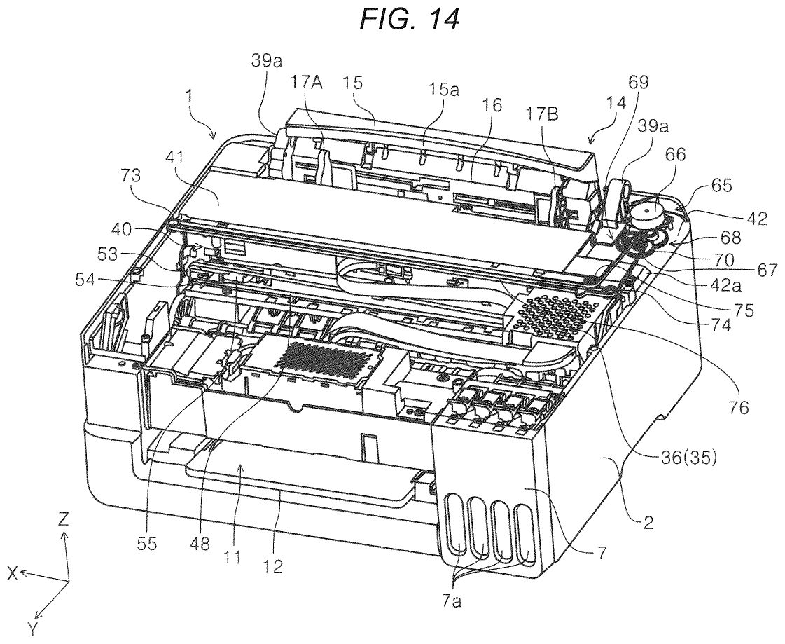

FIG. 15 is an enlarged view of an essential part of FIG. 14.

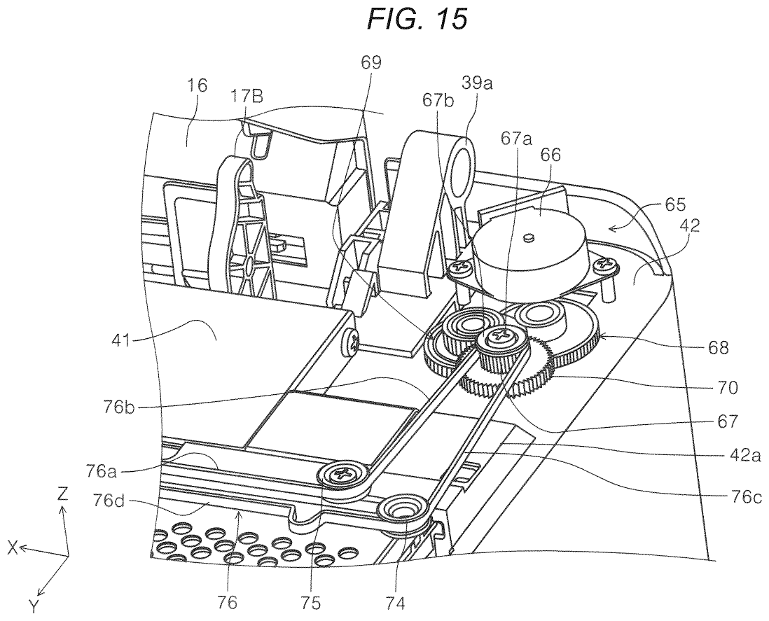

FIG. 16 is a perspective view of a part of a sensor carriage viewed from below.

### DESCRIPTION OF EMBODIMENTS

The present disclosure will be schematically described below.

An image reading apparatus according to a first aspect includes a platen on which a document is placed, a reading section that has a shape extending along a first axis and is configured to read the document placed at the platen by moving along a second axis crossing the first axis, a drive unit including a motor that is a power source for moving the reading section and a driving pulley driven by the motor, a plurality of driven pulleys configured to be driven to rotate, an endless belt wound around the driving pulley and the plurality of driven pulleys and configured to pull the reading section in accordance with rotation of the motor, a case configured to constitute a base body of the apparatus and including a housing recess configured to house the drive unit, and a flexible flat cable curved to form a turn-around region between a first holding region provided to the case and a second holding region provided to the reading section, wherein the plurality of driven pulleys includes a first driven pulley, a second driven pulley, and a third driven pulley, a straight line connecting a center of a rotary shaft of the first driven pulley and a center of a rotary shaft of the second driven pulley extends along the first axis, one direction of directions along the first axis is defined as a first direction, an opposite direction to the first direction is defined as a second direction, one direction of directions along the second axis is defined as a third direction, an opposite direction to the third direction is defined as a fourth direction, the second driven pulley is located at the third direction side with respect to the first driven pulley from a viewpoint of the second axis, the third driven pulley is located at the first direction side with respect to the second driven pulley from a viewpoint of the first axis and is located at the fourth direction side with respect to the second driven pulley from the viewpoint of the second axis, and the drive unit is located at the first direction side with respect to the third driven pulley from the viewpoint of the first axis, the driving pulley is located at the fourth direction side with respect to the second driven pulley from the viewpoint of the second axis, at least a part of the drive unit is located at a position overlapping the reading section when viewed from a normal direction with respect to the platen when the reading section is located at an end portion in the third direction in a movement area, a section of the endless belt between the first driven pulley and the third driven pulley is defined as a first belt section, the first holding region, the second holding region, and the flexible flat cable are located at the first direction side with respect to the first belt section from the viewpoint of the first axis, and the turn-around region of the flexible flat cable is closest to the reading section when the reading section is located at an end portion in the third direction in the movement area, and the flexible flat cable and the drive unit overlap each other when viewed from the normal direction when the reading section is located in the end portion in the third direction in the movement area, and the overlap between the flexible flat cable and the drive unit is eliminated by the reading section moving in the fourth direction from the end portion in the third direction in the movement area.

Due to the arrangement of the drive unit and the flexible flat cable, the flexible flat cable and the drive unit may overlap in some cases when viewed from the normal direction. In this case, in order to prevent the flexible flat cable and the drive unit from coming into contact with each other, it is necessary to largely separate the flexible flat cable and the drive unit from each other in the vertical direction. This is because the flexible flat cable tends to hang vertically downward due to the gravity. However, when the flexible flat cable and the drive unit are largely separated from each other in the vertical direction, an increase in the dimension in the height direction of the apparatus is incurred.

Here, the turn-around region of the flexible flat cable is likely to hang vertically downward as the turn-around region gets away from the reading section, that is, from the second holding region. Therefore, when the drive unit is located below the turn-around region in such a state, the turn-around region and the drive unit easily come into contact with each other. Therefore, the flexible flat cable and the drive unit need to be largely separated from each other in the vertical direction, which incurs an increase in the dimension in the height direction of the apparatus.

According to the present aspect, the turn-around region of the flexible flat cable is closest to the reading section, that is, the second holding region when the reading section is located at the end portion in the third direction in the movement area. Therefore, in this state, the turn-around region is less likely to hang vertically downward. Further, in this state, the flexible flat cable and the drive unit overlap each other when viewed from the normal direction. Therefore, it is not necessary to largely separate the flexible flat cable and the drive unit from each other in the vertical direction, and an increase in the dimension in the height direction of the apparatus can be suppressed.

Then, when the reading section moves in the fourth direction from the end portion in the third direction in the movement area from this state, the overlap is eliminated. Therefore, the contact between the flexible flat cable and the drive unit can be suppressed.

A second aspect is an aspect according to the first aspect, wherein a section between the third driven pulley and the driving pulley is defined as a second belt section, a section between the driving pulley and the second driven pulley is defined as a third belt section, and a section between the second driven pulley and the first driven pulley is defined as a fourth belt section, the first belt section extends along the second axis, and when the reading section is located at the end portion in the third direction of the movement area, an entire area of the second belt section overlaps the reading section when viewed from the normal direction.

According to this aspect, the first belt section extends along the second axis, and when the reading section is located at the end portion in the third direction of the movement area, the entire area of the second belt section overlaps the reading section when viewed from the normal direction, and thus the first belt section and the second belt section are less likely to overlap the movement area of the flexible flat cable when viewed from the normal direction. Accordingly, the contact between the flexible flat cable and the endless belt can be suppressed.

A third aspect is an aspect according to the second aspect, wherein a part of the flexible flat cable and a part of the third belt section overlap each other viewed from the normal direction when the reading section is located at the end portion in the third direction in the movement area.

According to this aspect, when the reading section is located at the end portion in the third direction in the movement area, the flexible flat cable and the part of the third belt section overlap each other when viewed from the normal direction, but in this state, as described above, since the flexible flat cable is in a state of being unlikely to hang vertically downward, it is possible to suppress the contact between the flexible flat cable and the third belt section.

A fourth aspect is an aspect according to the second aspect, wherein when the reading section is located at the end portion in the third direction in the movement area, a part of the driving pulley and a part of the reading section overlap each other when viewed from the normal direction, and the reading section is provided with a clearance portion configured to avoid the driving pulley or a fixing member configured to fix the driving pulley when the reading section is located at the end portion in the third direction in the movement area.

According to the present aspect, when the reading section is located at the end portion in the third direction in the movement area, a part of the driving pulley and a part of the reading section overlap each other when viewed from the normal direction, and the reading section is provided with a clearance portion configured to avoid the driving pulley or a fixing member configured to fix the driving pulley when the reading section is located at the end portion in the third direction in the movement area, and thus it is possible to reduce the total thickness of the reading section and the driving pulley in the vertical direction, and to suppress the dimension in the vertical direction of the apparatus.

Note that the present aspect may be not only according to the second aspect described above but also according to the third aspect described above.

A fifth aspect is an aspect according to the first aspect, wherein an upper portion of the housing recess is opened to thereby expose the drive unit.

According to the present aspect, since the housing recess is in the open state and the drive unit is exposed, it is possible to suppress an increase in cost of the apparatus and to suppress a dimension in the height direction of the apparatus compared to a configuration in which an upper side of the drive unit is covered with a cover. Further, also in such a configuration, it is possible to suppress the contact between the flexible flat cable and the drive unit due to the functions and the advantages in the first aspect described above.

Note that the present aspect may be not only according to the first aspect described above but also according to any one of the second to fourth aspects described above.

A sixth aspect is an aspect according to the first aspect wherein the reading section includes a pressing member configured to apply tension to the endless belt.

According to the present aspect, since the reading section includes the pressing member that applies tension to the endless belt, it is possible to realize a configuration of applying tension to the endless belt in a space-saving manner.

A recording apparatus according to a seventh aspect includes a recording unit including a recording section configured to perform recording on a medium, and the image reading apparatus according to any one of the first to sixth aspects that is rotatably coupled to the recording unit and rotates to thereby be switchable between a closed state in which an upper portion of the recording unit is covered and an open state in which the upper portion of the recording unit is opened.

According to the present aspect, in the recording apparatus, the functions and advantages of any one of the first to sixth aspects described above can be obtained.

An eighth aspect is an aspect according to the seventh aspect, wherein the recording unit includes a medium support section configured to support the medium to be fed in an inclined posture, a feed roller configured to feed the medium from the medium support section, and a frame that is located between the medium support section and the recording section, and includes a first frame surface facing the feed roller, and a second frame surface that is opposite to the first frame surface and faces the recording section, the case includes a protruding region that is a region forming the housing recess and protrudes downward from the case, and in the closed state of the image reading apparatus, the protruding region is located at a lateral side of the medium support section in a width direction crossing a feeding direction of the medium from the medium support section, and at least a part of the protruding region is located vertically below an upper end portion of the frame.

According to the present aspect, in the closed state of the image reading apparatus, since the protruding region is located at the lateral side of the medium support section in the width direction and at least a part of the protruding region is located vertically below the upper end portion of the frame, the protruding region is less likely to affect the dimension in the height direction of the recording apparatus, and the dimension in the height direction of the apparatus can be suppressed.

A ninth aspect is an aspect according to the eighth aspect, wherein the recording unit includes a carriage configured to move in the width direction, a recording head mounted on the carriage, and a maintenance unit that is disposed outside a medium conveyance area and in an end portion at one side in a movable area of the carriage in the width direction and is configured to perform maintenance on the recording head, and at least a part of the maintenance unit and at least a part of the protruding region overlap each other in the width direction.

In the configuration in which the maintenance unit that performs maintenance on the recording head is disposed outside a medium conveyance area and in the end portion at one end of the movable area of the carriage in the width direction, an empty space is formed at a lateral side of the medium support section.

According to the present embodiment, since the protruding region is disposed in such an empty space, the empty space can be effectively used, and an increase in size of the apparatus can be suppressed.

The present disclosure will specifically be described below.

An inkjet printer 1 that performs recording, by ejecting ink as an example of a liquid, onto a medium typified by recording paper will hereinafter be described as an example of the recording apparatus. The inkjet printer 1 will hereinafter be abbreviated as a printer 1.

The X-Y-Z coordinate system illustrated in each drawing is an orthogonal coordinate system, and in each of the X axis, the Y axis, and the Z axis, a direction indicated by an arrow is defined as a “+” direction, and the opposite direction is defined as a “−” direction. The Y-axis direction is a conveyance direction of the medium during recording, and is an apparatus depth direction. In the present embodiment, out of side surfaces forming a circumference of the printer 1, the side surface at the +Y direction side is a front surface, and the side surface at the −Y direction side is a back surface.

The X-axis direction is an apparatus width direction, and the +X direction side corresponds to the left side and the −X direction side corresponds to the right side when viewed from an operator of the printer 1. Further, the X-axis direction is a medium width direction. Hereinafter, the X-axis direction may be simply referred to as a width direction.

The Z-axis direction is a vertical direction, that is, an apparatus height direction, the +Z direction is an upward direction, and the −Z direction is a downward direction.

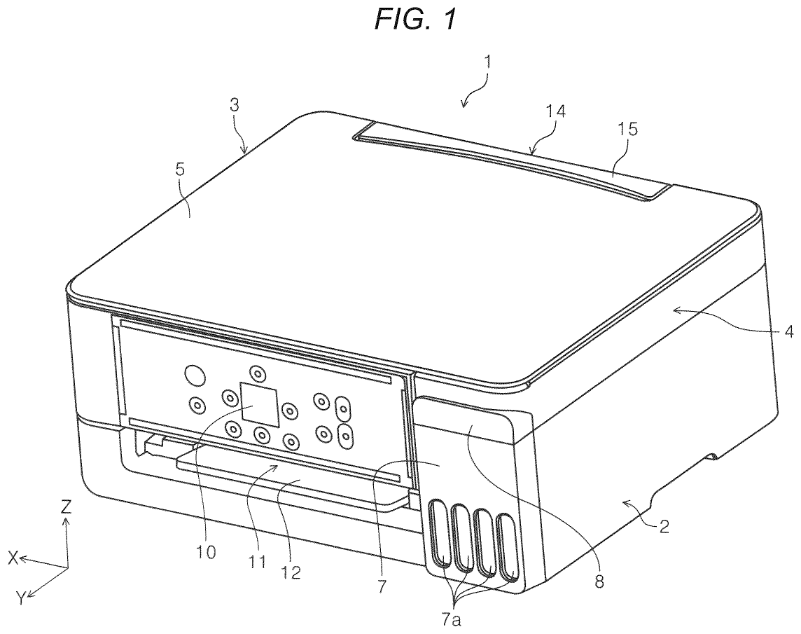

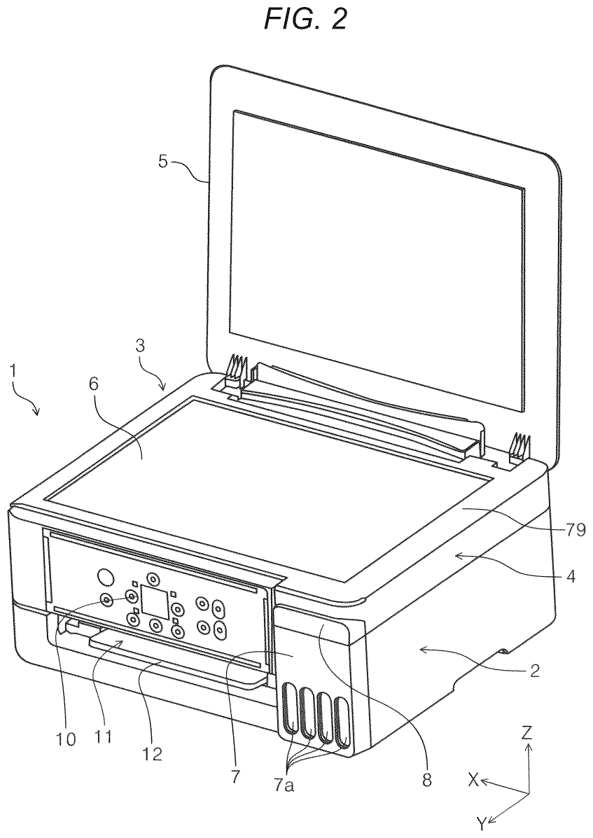

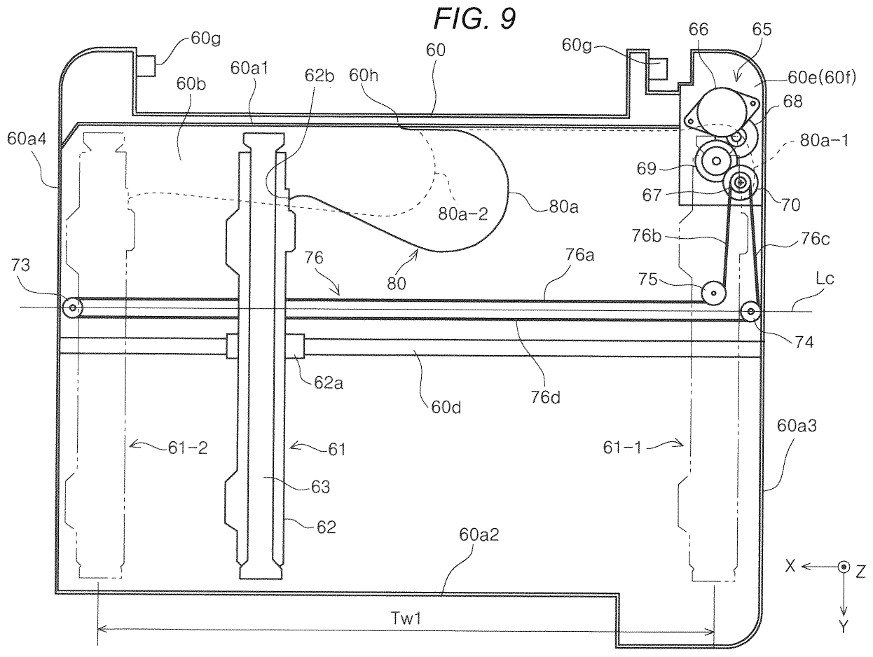

As illustrated in FIG. 1, the printer 1 is configured as a multifunction machine including a recording unit 2 and a scanner unit 3 disposed above the recording unit 2. The scanner unit 3, which is an example of an image reading apparatus that reads an image of a document, includes a reading unit 4 and a document cover 5 disposed above the reading unit 4. The document cover 5 is disposed to be rotatable with respect to the reading unit 4, and when the document cover 5 opens, a platen 6 constituting the reading unit 4 is exposed as illustrated in FIG. 2. The platen 6 is formed of, for example, a glass plate. A reading section 61 (see FIG. 9) described later is disposed below the platen 6.

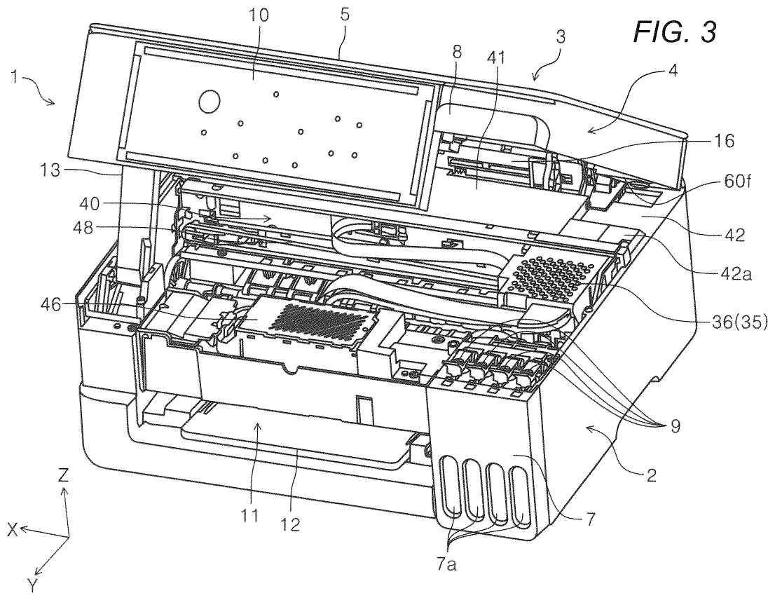

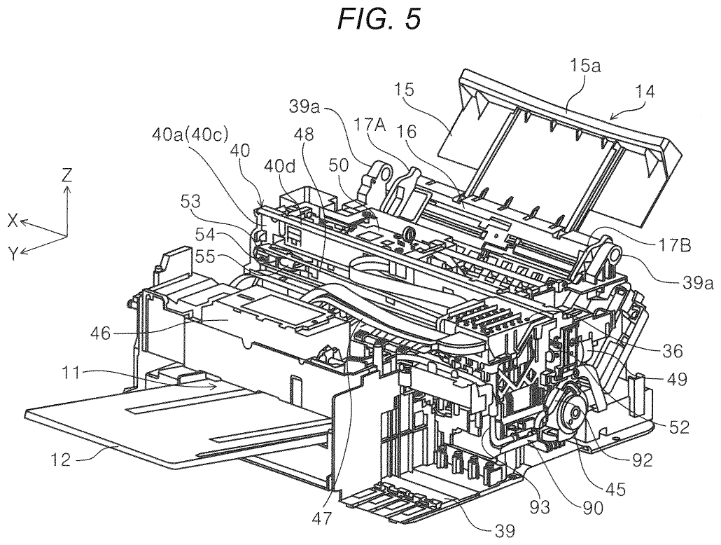

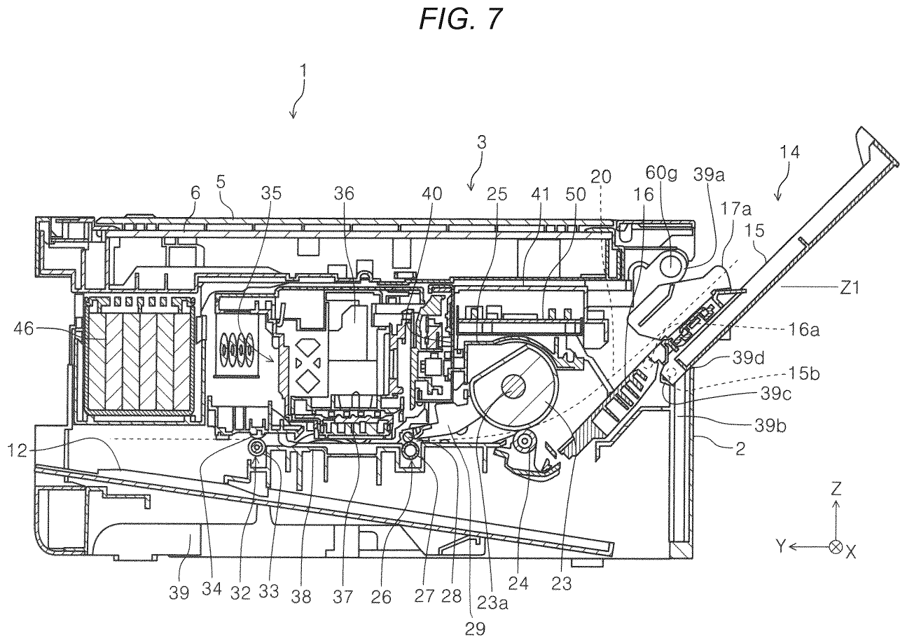

The scanner unit 3 is rotatably coupled to the recording unit 2 via a rotary shaft 60g (see FIG. 7), and can take a closed state as illustrated in FIG. 1 and an open state as illustrated in FIG. 3 by rotating. The rotary shaft 60g is supported by a bearing portion 39a (see FIGS. 5 and 7) of a base frame 39 constituting a base body of the recording unit 2.

In FIG. 3, the reference numeral 13 denotes a support arm, and the support arm 13 holds a state in which the scanner unit 3 opens. When the scanner unit 3 is opened, an inside of the recording unit 2 is exposed.

In FIG. 1, an operation panel 10 is disposed at the front side of the recording unit 2. The operation panel 10 can be tilted, and can take a state in which a panel surface is along the vertical direction as illustrated in FIG. 1 and a state in which the panel surface faces upward (not illustrated).

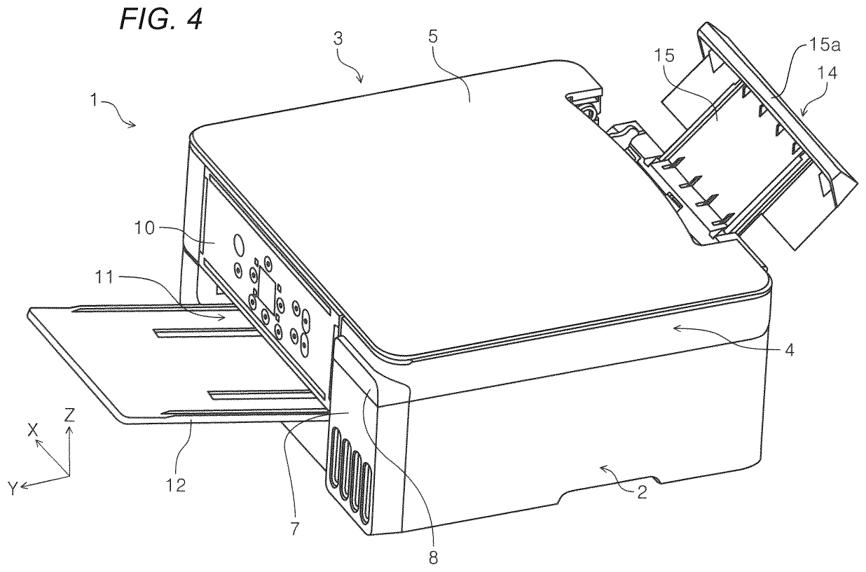

A discharge port 11 is formed at the front side of the recording unit 2. A medium catch tray 12 is provided to the discharge port 11. The medium catch tray 12 is configured to be switchable between a retracted state illustrated in FIG. 1 and a pull-out state illustrated in FIG. 4 with respect to the recording unit 2.

Further, an ink container 7 is disposed at the front side of the recording unit 2. The ink container 7 can store a plurality of colors of ink, such as yellow ink, magenta ink, cyan ink, and black ink. A remaining amount view window 7a for viewing a remaining amount of the ink is disposed at the front surface side of the ink container 7.

A cover 8 is disposed above the ink container 7. The cover 8 is provided integrally with the scanner unit 3, and when the scanner unit 3 is opened, an upper portion of the ink container 7 is exposed as illustrated in FIG. 3.

In FIG. 3, the reference numeral 9 denotes a cap lever. The cap lever 9 can be opened and closed, and an ink inlet (not illustrated) can be exposed by opening the cap lever 9. Further, the ink can be replenished from the ink inlet.

As illustrated in FIGS. 4, 5, and 7, a medium support section 14 that supports the medium to be fed in an inclined posture is disposed at the back surface side of the recording unit 2.

The medium support section 14 includes a support portion 15 and a swing support portion 16. The swing support portion 16 is swingable around a swing shaft 16a (see FIG. 7), and swings with the power of a motor (not illustrated) to thereby bring the medium thus supported into contact with a feed roller 23.

As illustrated in FIG. 5, the swing support portion 16 is provided with edge guides 17A and 17B that guide edges in the width direction of the medium. The edge guides 17A and 17B are disposed so as to come closer to or get away from each other along the width direction of the medium with a rack-and-pinion mechanism (not illustrated).

The support portion 15 can take an expanded state shown in FIGS. 4, 5, and 7 and a retracted state shown in FIG. 1. The support portion 15 takes an inclined posture in the expanded state illustrated in FIGS. 4, 5, and 7. Further, the support portion 15 takes a vertical posture in the retracted state in FIG. 1 and is retracted at the back surface side of the base frame 39. As illustrated in FIG. 7, a guide portion 39b extending along the vertical direction is formed at the back surface side of the base frame 39. A swing shaft 15b is provided to the support portion 15 so as to be movable in the guide portion 39b along the vertical direction.

In the retracted state of the support portion 15, the swing shaft 15b is located at a lower end portion of the guide portion 39b. When the user pulls up the support portion 15 in this state into the inclined posture, the swing shaft 15b enters a holding portion 39c disposed at an upper portion of the guide portion 39b. Then, a back surface side of the support portion 15 comes into contact with the contact portion 39d of the base frame 39, and the inclined posture is maintained.

As illustrated in FIGS. 1, 4, and 5, a curved support portion 15a is provided to an upper portion of the support portion 15. The medium supported by the support portion 15 is provided with a curve protruding downward along the width direction by the curved support portion 15a, and thus the upper end portion of the medium is suppressed from hanging down rearward.

The conveyance path 20 of the medium in the recording unit 2 will hereinafter be described with reference to FIG. 7. Hereinafter, a direction in which the medium is conveyed may be referred to as “downstream”, and the opposite direction may be referred to as “upstream” in some cases. In FIG. 7, a conveyance path 20 of the medium is represented by a broken line. In the printer 1, the medium is conveyed through the conveyance path 20.

The medium support section 14 described above is disposed at the extreme upstream of the conveyance path 20.

The media supported by the medium support section 14 are nipped and separated from each other by the feed roller 23 driven by the motor (not illustrated) and a separation roller 24 to which rotational resistance is applied, and are each sent toward a conveyance roller pair 26.

Note that the reference numeral 23a denotes a rotary shaft of the feed roller 23. The reference numeral 25 denotes a support member that supports one end of the rotary shaft 23a. The support member 25 is fixed to a main frame 40 described later.

The conveyance roller pair 26 includes a conveyance driving roller 27 driven by a conveyance motor (not illustrated) and a conveyance driven roller 28 that nips the medium with the conveyance driving roller 27. The conveyance driven roller 28 is rotatably supported by a roller support member 29.

In the present embodiment, the conveyance driving roller 27 is a shaft body extending in the width direction. Further, in the present embodiment, a plurality of conveyance driven rollers 28 is disposed at appropriate intervals along the width direction with respect to the conveyance driving roller 27.

The roller support member 29 is swingably attached to the main frame 40 via a swing shaft (not illustrated), and swings to thereby cause the conveyance driven rollers 28 to advance and retreat with respect to the conveyance driving roller 27. The roller support member 29 is pressed in a direction in which the conveyance driven roller 28 advances with respect to the conveyance driving roller 27 with a pressing member (not illustrated) such as a torsion spring or a tension spring.

A recording section 35 includes a carriage 36 and a recording head 37. The carriage 36 is supported by the main frame 40 and is guided in the width direction. The carriage 36 receives the power of a carriage motor 49 (see FIG. 5) to reciprocate in the width direction.

The recording head 37 is disposed below the carriage 36. The recording head 37 is provided with a plurality of ink ejection nozzles (not illustrated) capable of ejecting the ink in the −Z direction. The ink container 7 and the carriage 36 described above are coupled with an ink tube 47 (see FIG. 5), and the ink is supplied from the ink container 7 with the ink tube 47.

Note that the ink container 7 is independent of the carriage 36 in the printer 1 according to the present embodiment, but the ink container 7 may be provided to the carriage 36. In addition, the recording section 35 according to the embodiment has a configuration in which the recording head 37 ejects the ink while moving in the width direction, that is, a serial type, but is not limited thereto, and may have a configuration in which the ink ejection nozzles are arranged so as to cover the entire area in the width direction, and recording can be performed without moving in the width direction, that is, may be formed of a line head.

Further, the recording method is not limited to an inkjet method, and may be a dot impact method or an electrophotographic method such as a laser method or an LED method.

Then, a support member 38 that supports the medium is disposed at a position that can face the recording head 37. The support member 38 defines a distance between the medium and the recording head 37. Then, the recording head 37 ejects the ink to the medium supported by the support member 38 to perform recording on a recording surface of the medium. The medium on which recording has been executed is nipped by a discharge roller pair 32 disposed downstream of the recording head 37 in the conveyance path 20, and is discharged toward the medium catch tray 12.

The discharge roller pair 32 includes a discharge driving roller 33 driven by the conveyance motor (not illustrated) and a discharge driven roller 34 that nips the medium with the discharge driving roller 33.

In the present embodiment, a plurality of discharge roller pairs 32 is disposed at appropriate intervals along the width direction. Further, in the present embodiment, the discharge driven roller 34 is a toothed roller having teeth on an outer circumference. The discharge driven roller 34 can advance and retreat with respect to the discharge driving roller 33, and nips the medium with the discharge driving roller 33 by using a bar spring as a rotary shaft.

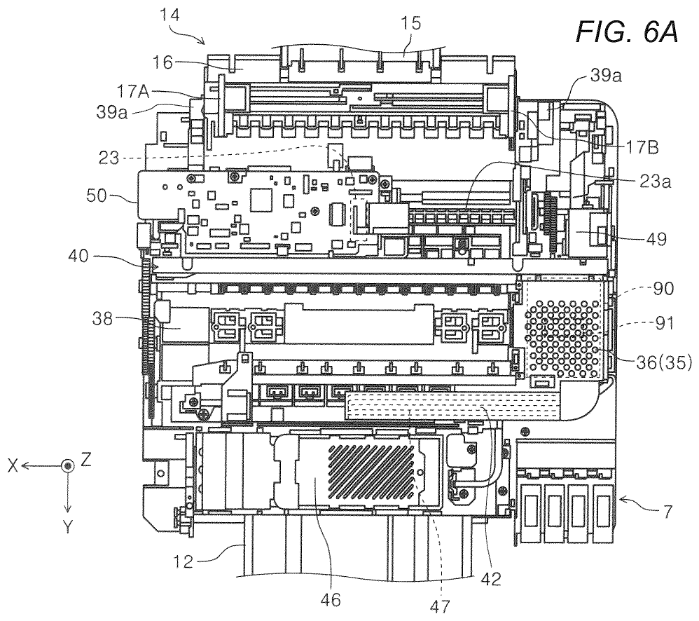

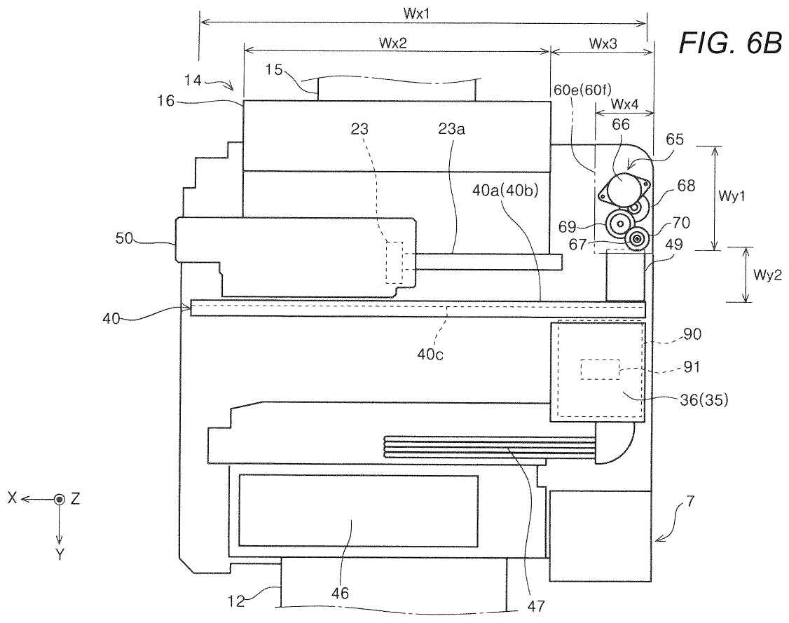

Note that as illustrated in FIGS. 5, 6A, and 6B, a maintenance unit 90 is disposed at an end portion in the −X direction in a reciprocation area of the carriage 36. The maintenance unit 90 is provided with a cap 91 capable of sealing the ink ejection surface of the recording head 37. As illustrated in FIG. 5, a suction pump 45 is disposed at a position adjacent to the maintenance unit 90, and the suction pump 45 and the cap 91 are coupled to each other with a tube 92. Accordingly, when the suction pump 45 is operated, negative pressure is supplied to an inside of the cap 91, and waste ink is sucked to the inside of the cap 91.

The waste ink sucked by the suction pump 45 is sent, with a tube 93, to and collected in a waste liquid container 46. The waste liquid container 46 is disposed in an upper portion at the front side of the apparatus.

The suction pump 45 is driven by the conveyance motor (not illustrated). When the rotation direction of the conveyance motor when conveying the medium downstream is defined as a forward rotation direction, the suction pump 45 operates only when the conveyance motor rotates in a reverse rotation direction.

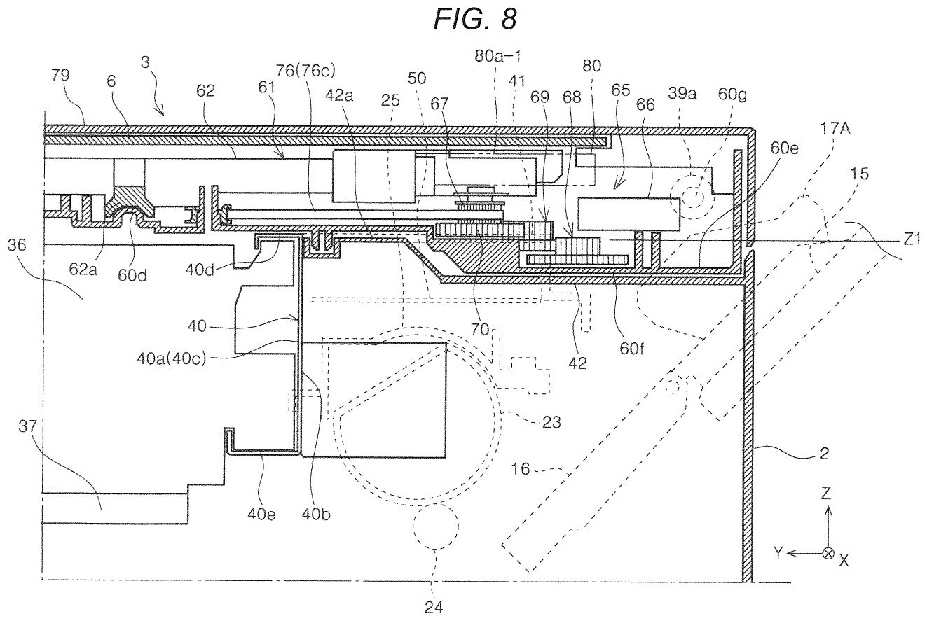

Then, a configuration of the main frame 40 and a periphery thereof will be described. The main frame 40 is a frame constituting a base body of the recording unit 2. Referring to FIG. 8, the main frame 40 is formed by bending a metal plate material so as to have a vertical frame portion 40a, an upper bent portion 40d, and a lower bent portion 40e. An end portion in the +Y direction of the upper bent portion 40d is further bent in the −Z direction. Further, the end portion in the +Y direction of the lower bent portion 40e is further bent in the +Z direction. The upper bent portion 40d constitutes an upper end portion of the main frame 40.

The vertical frame portion 40a is a region forming a surface parallel to the X-Z plane, and has a first frame surface 40b which is a surface at the back surface side, and a second frame surface 40c which is a surface at the front surface side and is a surface opposite to the first frame surface 40b.

The upper bent portion 40d and the lower bent portion 40e are regions forming surfaces parallel to the X-Y plane.

The main frame 40 is located between the medium support section 14 and the recording section 35, wherein the first frame surface 40b faces the feed roller 23, and the second frame surface 40c faces the recording section 35. A main board 50 is disposed in a horizontal state at the back surface side of the main frame 40. A part of the main board 50 is supported by the support member 25.

The main board 50 constitutes a control unit that performs overall control of the printer 1, and has various electronic components and a connector mounted thereon.

The main board 50 is disposed at the back surface side of the main frame 40 and below a cover member 41 (see FIG. 3). FIG. 5 shows a state in which the cover member 41 is removed to expose the main board 50.

As illustrated in FIGS. 5, 6A, and 6B, the carriage motor 49 is disposed at the first frame surface 40b side of the vertical frame portion 40a. In addition, in the vertical frame portion 40a, a carriage belt 48 (see FIG. 5) which pulls the carriage 36 is disposed at the second frame surface 40c side.

The roller support member 29 is swingably supported by the lower bent portion 40e. Further, the lower bent portion 40e supports the carriage 36 and guides the carriage 36 in the width direction.

As illustrated in FIG. 5, a driving pulley 52 is disposed at an end portion in the −X direction on the second frame surface 40c of the vertical frame portion 40a. Further, at the second frame surface 40c of the vertical frame portion 40a, a driven pulley 53 is disposed at an end portion in the +X direction. The carriage belt 48 is wound around the driving pulley 52 and the driven pulley 53. The driving pulley 52 is disposed at the rotary shaft of the carriage motor 49.

The driven pulley 53 is supported by a holder 54. The holder 54 is provided to be displaceable in the X-axis direction in the vertical frame portion 40a, and is pressed in the +X direction by a compression coil spring 55 as an example of a pressing member. Accordingly, tension along the X-axis direction is applied to the carriage belt 48.

Then, the configuration of the scanner unit 3 will be described in detail.

Note that the Y axis is an example of a first axis, the −Y direction in FIG. 9 is an example of a first direction, and the +Y direction is an example of a second direction. Further, the X axis is an example of a second axis, the −X direction in FIG. 9 is an example of a third direction, and the +X direction is an example of a fourth direction.

Further, FIG. 9 is a plan view of a case 60 viewed from the +Z direction, which is an example of a normal direction with respect to the platen 6 (see FIG. 2).

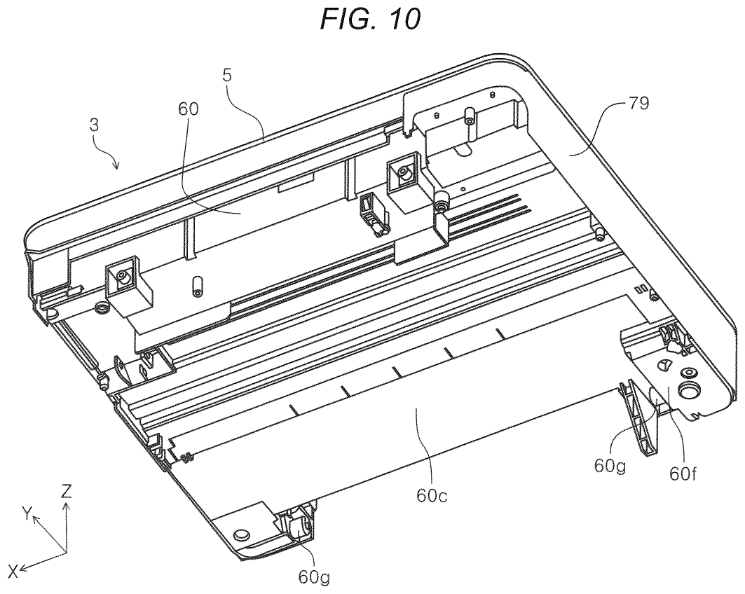

As illustrated in FIGS. 9 and 10, the scanner unit 3 uses the case 60 as a base body. As illustrated in FIG. 10, an upper housing 79 (see also FIG. 2) is disposed in an upper portion of the case 60. The upper housing 79 forms the periphery of the platen 6.

As illustrated in FIG. 9, the case 60 has a rectangular shape elongated in the X-axis direction as a whole, and includes a first wall portion 60a1 and a second wall portion 60a2 extending in the X-axis direction, and a third wall portion 60a3 and a fourth wall portion 60a4 extending in the Y-axis direction. The first wall portion 60a1 and the second wall portion 60a2 form surfaces parallel to the X-Z plane. The second wall portion 60a2 is located at the +Y direction side with respect to the first wall portion 60a1. The third wall portion 60a3 and the fourth wall portion 60a4 form surfaces parallel to the Y-Z plane. The fourth wall portion 60a4 is located at the +X direction side with respect to the third wall portion 60a3.

The reading section 61 has a shape extending along the Y axis and reads a document placed on the platen 6 (see FIG. 2) by moving along the X axis. The reading section 61 includes a sensor carriage 62 and a sensor module 63 mounted on the sensor carriage 62. The sensor module 63 is, for example, a contact image sensor (CIS).

A guide portion 60d parallel to the X axis is provided to the case 60. A guided portion 62a is provided to the sensor carriage 62, the guided portion 62a engages with the guide portion 60d, and the reading section 61 is guided in the X-axis direction by the guide portion 60d.

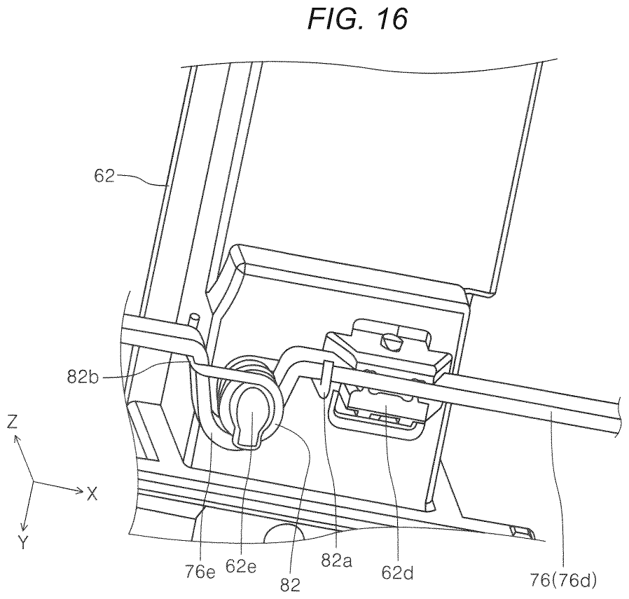

The sensor carriage 62 is pulled in the +X direction and the −X direction by the endless belt 76. As shown in FIG. 16, a belt clamp portion 62d is formed below the sensor carriage 62. By a part of the endless belt 76 entering the belt clamp portion 62d, the sensor carriage 62 is fixed to the part of the endless belt 76. The sensor carriage 62 is fixed to a part of a fourth belt section 76d described later.

Further, a spring holding portion 62e is formed in the vicinity of the belt clamp portion 62d. A coil spring 82, which is an example of a pressing member, is held by the spring holding portion 62e. A part of the endless belt 76 is wound around the coil spring 82 to form a winding portion 76e. A first arm portion 82a of the coil spring 82 is hung on the endless belt 76 extending in the +X direction from the spring holding portion 62e, and a second arm portion 82b of the coil spring 82 is hung on the endless belt 76 extending in the −X direction from the spring holding portion 62e. The second arm portion 82b applies a tensile force toward the +X direction to the endless belt 76 to thereby apply tension to the endless belt 76.

As described above, in the present embodiment, since the coil spring 82, which is a pressing member that applies tension to the endless belt 76, is provided to the reading section 61, it is possible to realize, in a space-saving manner, a configuration in which tension is applied to the endless belt 76.

Then, returning to FIG. 9, the case 60 is provided with a plurality of driven pulleys that can be driven to rotate. In the present embodiment, the plurality of driven pulleys includes a first driven pulley 73, a second driven pulley 74, and a third driven pulley 75. Further, a driving pulley 67 driven by a belt drive motor 66 is provided to the case 60. The endless belt 76 is wound around the first driven pulley 73, the second driven pulley 74, the third driven pulley 75, and the driving pulley 67, and pulls the reading section 61 as the belt drive motor 66 rotates.

The second driven pulley 74 is located at the −X direction side with respect to the first driven pulley 73 from the viewpoint of the X axis. In the present embodiment, the second driven pulley 74 is disposed at an end portion in the −X direction inside the case 60 and is adjacent to the third wall portion 60a3. Further, the first driven pulley 73 is disposed in an end portion in the +X direction inside the case 60 and is adjacent to the fourth wall portion 60a4.

The third driven pulley 75 is located at the −Y direction side with respect to the second driven pulley 74 from the viewpoint of the Y axis, and is located at the +X direction side with respect to the second driven pulley 74 from the viewpoint of the X axis. The driving pulley 67 is located at the +X direction side with respect to the second driven pulley 74 from the viewpoint of the X axis. The drive unit 65 is located at the −Y direction side with respect to the third driven pulley 75 from the viewpoint of the Y axis.

Note that in the endless belt 76, a section between the first driven pulley 73 and the third driven pulley 75 is defined as a first belt section 76a. Further, in the endless belt 76, a section between the third driven pulley 75 and the driving pulley 67 is defined as a second belt section 76b. Further, in the endless belt 76, a section between the driving pulley 67 and the second driven pulley 74 is defined as a third belt section 76c. Further, in the endless belt 76, a section between the second driven pulley 74 and the first driven pulley 73 is defined as the fourth belt section 76d.

A straight line Lc connecting the center of a rotary shaft of the first driven pulley 73 and the center of a rotary shaft of the second driven pulley 74 extends along the X axis. Therefore, the fourth belt section 76d extends along the X axis. Further, in the present embodiment, the first belt section 76a extends along the X axis. That is, the first belt section 76a and the fourth belt section 76d are parallel to each other.

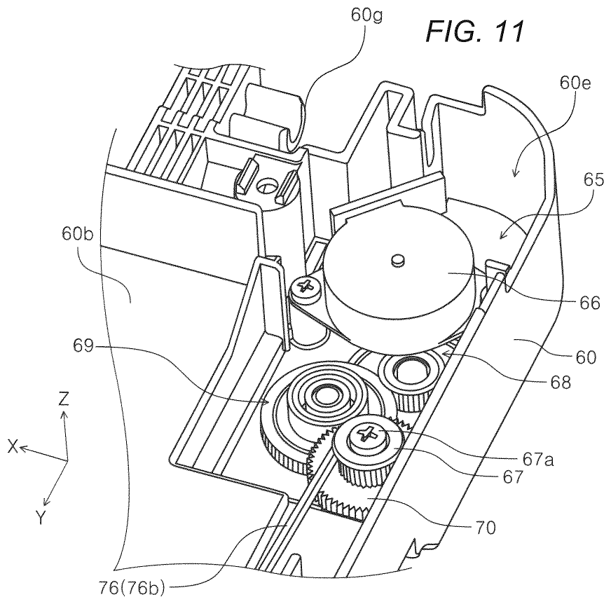

Then, a housing recess 60e is provided to the case 60. As illustrated in FIG. 11, the housing recess 60e is formed so as to be recessed in the −Z direction from an inner bottom surface 60b of the case 60. The housing recess 60e houses a drive unit 65 including the belt drive motor 66, which is a power source of the movement of the reading section 61, and the driving pulley 67.

In the present embodiment, the drive unit 65 further includes gears 68, 69, and 70 in addition to the belt drive motor 66 and the driving pulley 67. Axial center lines of the gears 68, 69, and 70 are parallel to the Z axis.

In the present embodiment, a motor shaft (not illustrated) of the belt drive motor 66 is parallel to the Z axis and protrudes in the −Z direction from a main body of the belt drive motor 66. A pinion (not shown) is provided to the motor shaft (not shown), and the pinion meshes with the gear 68. The gears 68, 69 are each a two-tiered gear, and a large gear of the gear 68 meshes with the pinion. A small gear of the gear 68 meshes with a large gear of the gear 69. A small gear of the gear 69 meshes with the gear 70. The gear 70 and the driving pulley 67 are integrally formed and fixed to the case 60 with a washer 67b and a fixing screw 67a.

As illustrated in FIG. 10, when the case 60 is viewed from below, the housing recess 60e forms a protruding region 60f protruding in the −Z direction from a lower surface 60c of the case 60. In the case 60, the housing recess 60e, that is, the protruding region 60f is located at an end portion in the −X direction from the viewpoint of the X axis, and is located at an end portion in the −Y direction from the viewpoint of the Y axis. In other words, the housing recess 60e, that is, the protruding region 60f is disposed at one corner out of four corners of the case 60. However, the housing recess 60e, that is, the protruding region 60f may be disposed at another corner out of the four corners of the case 60. For example, in the case 60, the housing recess 60e, that is, the protruding region 60f may be located at the end portion in the +X direction from the viewpoint of the X axis and may be located at the end portion in the −Y direction from the viewpoint of the Y axis.

Then, returning to FIG. 9, a flexible flat cable 80 is disposed inside the case 60. Hereinafter, the flexible flat cable 80 is abbreviated as FFC 80. The FFC 80 is disposed such that the width direction is parallel to the Z-axis direction. The first wall portion 60a1 of the case 60 is provided with a first holding region 60h that holds the FFC 80. Further, the sensor carriage 62 of the reading section 61 is provided with a second holding region 62b that holds the FFC 80. The FFC 80 forms a turn-around region 80a between the first holding region 60h and the second holding region 62b.

The first holding region 60h, the second holding region 62b, and a part of the FFC 80 between the first holding region 60h and the second holding region 62b are located at the −Y direction side with respect to the first belt section 76a from the viewpoint of the Y axis.

The FFC 80 extends in the −X direction from the second holding region 62b of the sensor carriage 62, forms the turn-around region 80a to change the direction to the +X direction, extends in the +X direction along the first wall portion 60a1, and enters the first holding region 60h. Then, the FFC 80 is coupled to the main board 50 (see FIG. 7). In the present embodiment, as an example, the turn-around region 80a is formed in a region at the extreme −X direction side of the FFC 80.

The FFC 80 deforms between the first holding region 60h and the second holding region 62b as the reading section 61 moves, and the turn-around region 80a moves as the reading section 61 moves. The reading section 61 indicated by a dashed-two dotted line denoted by the reference numeral 61-1 represents a state of moving to the extreme −X direction side in a movement area Tw1. Further, the reference numeral 80a-1 denotes the turn-around region 80a in this state.

Further, the reading section 61 indicated by a dashed-two dotted line denoted by the reference numeral 61-2 represents a state of moving to the extreme +X direction side in the movement area Tw1. Further, the reference numeral 80a-2 denotes the turn-around region 80a in this state.

As illustrated in the drawings, when the reading section 61 moves to the extreme −X direction side, the turn-around region 80a comes closest to the reading section 61 from the viewpoint of the X axis. As the reading section 61 moves in the +X direction from this state, the turn-around region 80a moves away from the reading section 61 from the viewpoint of the X axis.

Then, when the reading section 61 moves to the extreme +X direction side, the turn-around region 80a is separated the most from the reading section 61 from the viewpoint of the X axis. More specifically, when the reading section 61 moves to the extreme +X direction side, a region located at the extreme −X direction side of the turn-around region 80a is separated the most from the reading section 61 from the viewpoint of the X axis.

In this way, the turn-around region 80a advances and retreats with respect to the reading section 61 in accordance with the position of the reading section 61, but since the FFC 80 tends to hang down due to the action of gravity, downward hanging becomes remarkable as the turn-around region 80a is separated from the reading section 61, that is, from the second holding region 62b.

Here, due to the arrangement of the drive unit 65 and the FFC 80, there occurs in some cases a configuration in which the FFC 80 and the drive unit 65 overlap each other when viewed from the +Z direction. For example, since the main board 50 (see FIG. 7) is provided to the recording unit 2, a cable that electrically couples the recording unit 2 and the scanner unit 3 is preferably disposed at a position close to the rotary shaft 60g of the scanner unit 3. Therefore, the drive unit 65 is preferably disposed at a position close to the end portion in the −Y direction in the case 60. Further, interference between the endless belt 76 and the FFC 80 is also undesirable. From this viewpoint, the FFC 80 is preferably routed in an area at the −Y direction side with respect to the first belt section 76a of the endless belt 76.

Meanwhile, when the endless belt 76 is wound around only two pulleys, for example, the first driven pulley and the driving pulley 67, an arrangement area of the drive unit 65 protrudes in the −X direction to increase the apparatus dimension in the X-axis direction compared to the configuration of the present embodiment. Therefore, adopting the third driven pulley 75 and disposing the driving pulley 67 at the +X direction side with respect to the second driven pulley 74 from the viewpoint of the X axis as in the present embodiment contribute to the suppression of the apparatus dimension in the X-axis direction. Further, since the drive unit 65 is disposed at the −Y direction side with respect to the first belt section 76a from the viewpoint of the Y axis, there is provided a configuration in which the FFC 80 and the drive unit 65 easily overlap each other when viewed from the +Z direction. In particular, when the drive unit 65 is located at a further +X direction side compared to the present embodiment, the FFC 80 and the drive unit 65 more easily overlap each other.

In order to prevent the FFC 80 and the drive unit 65 from coming into contact with each other, it is necessary to largely separate the FFC 80 and the drive unit 65 from each other in a vertical direction. As described above, this is because the FFC 80 tends to hang down vertically due to the influence of the gravity. However, when the FFC 80 and the drive unit 65 are largely separated from each other in the vertical direction, an increase in dimension in a height direction of the apparatus is incurred.

Here, as described above, the turn-around region 80a of the FFC 80 is likely to hang vertically downward as the turn-around region 80a gets away from the reading section 61, that is, from the second holding region 62b. Therefore, when the drive unit 65 is located below the turn-around region 80a in such a state, the turn-around region 80a and the drive unit 65 easily come into contact with each other. Therefore, it is necessary to largely separate the FFC 80 and the drive unit 65 from each other in the vertical direction, which incurs an increase in the dimension in the height direction of the apparatus.

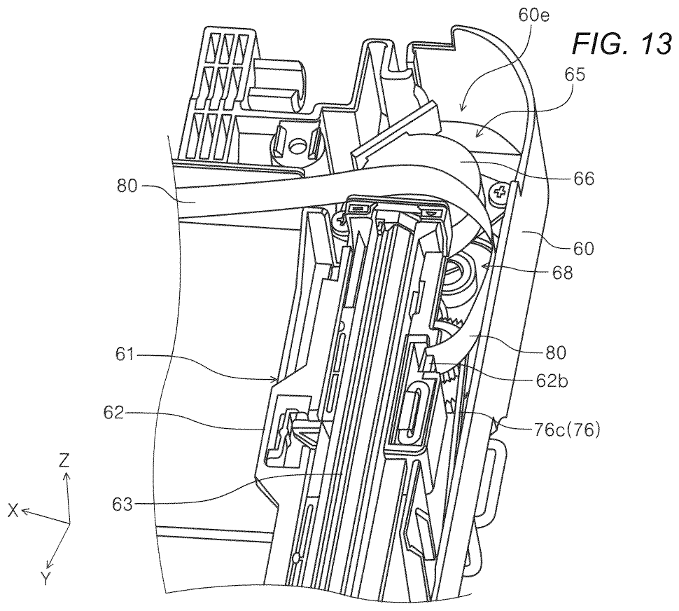

However, according to the present embodiment, when the reading section 61 is located at the end portion in the −X direction of the movement area Tw1, as illustrated in FIGS. 9, 12, and 13, at least a part of the drive unit 65 is located at a position overlapping the reading section 61 when viewed from the +Z direction. Note that in this case, the entire drive unit 65 may overlap the reading section 61.

Further, there is adopted a configuration in which the FFC 80 and the drive unit 65 overlap each other when viewed from the +Z direction when the reading section 61 is located at the end portion in the −X direction of the movement area Tw1, and the overlap is eliminated when the reading section 61 moves in the +X direction from the end portion in the −X direction of the movement area Tw1.

In the present embodiment, the turn-around region 80a of the FFC 80 is the closest to the reading section 61, that is, the second holding region 62b when the reading section 61 is located at the end portion in the −X direction of the movement area Tw1. Therefore, in this state, the turn-around region 80a is less likely to hang vertically downward. Further, in this state, the FFC 80 and the drive unit 65 overlap each other when viewed from the +Z direction. Therefore, it is not necessary to largely separate the FFC 80 and the drive unit 65 from each other in the vertical direction, and an increase in the dimension in the height direction of the apparatus can be suppressed.

Then, when the reading section 61 moves, from this state, in the +X direction from the end portion in the −X direction of the movement area Tw1, the overlap between the FFC 80 and the drive unit 65 is eliminated. Therefore, a contact between the FFC 80 and the drive unit 65 can be suppressed.

Further, in the present embodiment, the first belt section 76a extends along the X axis. Further, when the reading section 61 is located at the end portion in the −X direction of the movement area Tw1, since the entire area of the second belt section 76b overlaps the reading section 61 when viewed from the +Z direction as illustrated in FIG. 9, the first belt section 76a and the second belt section 76b are less likely to overlap the movement area of the FFC 80 when viewed from the +Z direction. Accordingly, the contact between the FFC 80 and the endless belt 76 can be suppressed.

Further, in the present embodiment, when the reading section 61 is located at the end portion in the −X direction of the movement area Tw1, a part of the FFC 80 and a part of the third belt section 76c overlap each other when viewed from the +Z direction. In this case, since the FFC 80 is in the state of being unlikely to hang vertically downward as described above, the contact between the FFC 80 and the third belt section 76c can be suppressed.

Further, in the present embodiment, as illustrated in FIG. 9, when the reading section 61 is located at the end portion in the −X direction of the movement area Tw1, a part of the driving pulley 67 and a part of the reading section 61 overlap each other when viewed from the +Z direction.

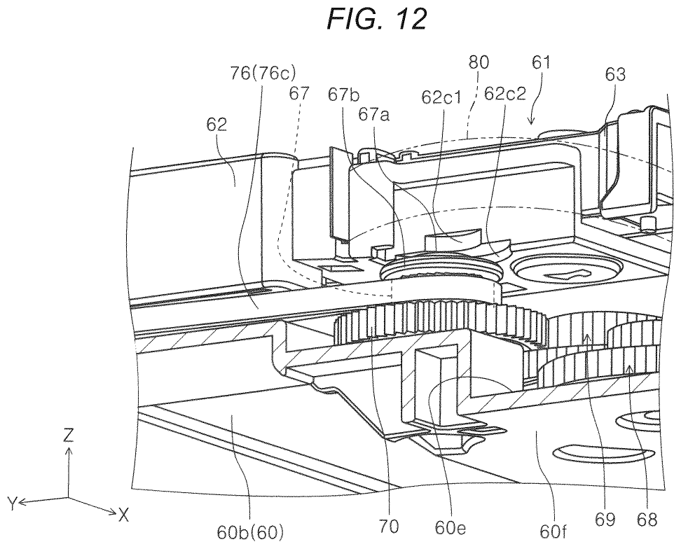

Further, as illustrated in FIG. 12, the reading section 61 is provided with a clearance portion that avoids the fixing screw 67a and the washer 67b which are fixing members for fixing the driving pulley 67, when the reading section 61 is located at the end portion in the −X direction in the movement area Tw1. The clearance portion includes a first clearance portion 62c1 that avoids the fixing screw 67a and a second clearance portion 62c2 that avoids the washer 67b.

With such a configuration, a total thickness of the reading section 61 and the driving pulley 67 in the vertical direction can be reduced, and the dimension in the vertical direction of the apparatus can be suppressed.

Note that the fixing screw 67a is not necessarily required to enter the first clearance portion 62c1 in the vertical direction. Further, similarly, the washer 67b is not necessarily required to enter the second clearance portion 62c2 in the vertical direction. This is because it is not necessary to ensure a large gap in the Z-axis direction between the fixing screw 67a and the reading section 61 and a large gap in the Z-axis direction between the washer 67b and the reading section 61 since such a clearance portion is formed, which contributes to suppression of the dimension in the vertical direction of the apparatus.

Note that a clearance portion that avoids the driving pulley 67 may be formed.

Further, as illustrated in FIG. 11, in the present embodiment, an upper portion of the housing recess 60e is opened, and the drive unit 65 is exposed. Accordingly, compared to a configuration in which an upper side of the drive unit 65 is covered with a cover, an increase in the cost of the apparatus can be suppressed, and the dimension in the height direction of the apparatus can also be suppressed. Further, also in such a configuration, the contact between the FFC 80 and the drive unit 65 can be suppressed by the function and the advantage described above.

Then, an arrangement relationship between the drive unit 65 and the recording unit 2 will be described.

As described above, the scanner unit 3 is rotatably coupled to the recording unit 2, and rotates to thereby be switchable between a closed state in which the upper portion of the recording unit 2 is covered and an open state in which the upper portion of the recording unit 2 is opened.

Further, in the closed state of the scanner unit 3, as illustrated in FIG. 6B, the protruding region 60f is located at a lateral side, specifically, at the −X direction side of the medium support section 14 in the X-axis direction, that is, in the width direction. Further, as illustrated in FIG. 8, a part of the protruding region 60f is located vertically below the upper end portion of the main frame 40. Further, in the present embodiment, a part of the drive unit 65 is located vertically below the upper end portion of the main frame 40. In FIGS. 7 and 8, the position Z1 is a position of an upper end portion of the main frame 40 in the Z-axis direction. As a result, the protruding region 60f is less likely to affect the dimension in the height direction of the printer 1, and the dimension in the height direction of the printer 1 can be suppressed.

Note that in the present embodiment, a part of the protruding region 60f is located vertically below the upper end portion of the main frame 40, but the entire protruding region 60f may be located vertically below the upper end portion of the main frame 40.

Further, the position of the upper surface of the cover member 41 described with reference to FIG. 3 is located at the position Z1. Accordingly, as illustrated in FIG. 8, the protruding region 60f and the cover member 41 overlap each other in the vertical direction, in other words, the protruding region 60f and the cover member 41 overlap each other when viewed in the horizontal direction.

Further, as illustrated in FIG. 6B, at least a part of the maintenance unit 90 and at least a part of the protruding region 60f overlap each other in the X-axis direction, that is, the width direction. In other words, at least a part of the maintenance unit 90 and at least a part of the protruding region 60f are located at the same position in the width direction.

In FIG. 6B, the reference characters Wx2 denote a medium conveyance area in the width direction, and the reference characters Wx1 denote a movable area of the carriage 36 in the width direction. The reference characters Wx4 denote a region in the width direction of the protruding region 60f.

In a configuration in which the maintenance unit 90 that performs maintenance on the recording head 37 (see FIG. 7) is disposed outside the medium conveyance area Wx2 in the width direction and in an end portion at one side of the movable area Wx1 of the carriage 36, an empty space is likely to be formed at a lateral side of the medium support section 14. The reference characters Wx3 denote an area in the width direction of the empty space. By disposing the protruding region 60f in such an empty space, the empty space can be effectively used, and an increase in size of the apparatus can be suppressed.

Note that as is clear from FIG. 6B, the region Wx4 in the width direction of the protruding region 60f and a region in the width direction of the carriage motor 49 overlap each other in the width direction. In addition, in FIG. 6B, the reference characters Wy1 denote a region in the Y-axis direction of the protruding region 60f, and the reference characters Wy2 denote a region in the Y-axis direction of the carriage motor 49. In the present embodiment, a part of the region Wy1 and a part of the region Wy2 overlap each other in the Y-axis direction.

Further, in the present embodiment, as illustrated in FIG. 8, the housing recess 60e, in other words, the protruding region 60f overlaps the edge guide 17A when viewed from the width direction.

Further, when viewed from the width direction, the belt drive motor 66 and the bearing portion 39a overlap each other.

In addition, in FIG. 3, reference numeral 42 denotes a housing which forms an upper surface of the recording unit 2, and the housing 42 is provided with a convex portion 42a which protrudes in the +Z direction. Elements of the recording unit 2 can be housed inside the convex portion 42a.

Then, as illustrated in FIG. 8, in a state where the scanner unit 3 is closed, the convex portion 42a and the protruding region 60f overlap each other in the vertical direction.

With the above configuration, it is possible to suppress an increase in size of the apparatus.

The present disclosure is not limited to the embodiment and modified examples described above, but various modifications can be made within the scope of the disclosure set forth in the appended claims, and it is obvious that these modifications also fall within the scope of the present disclosure.

What is claimed is:

1. An image reading apparatus comprising:
a platen on which a document is placed;
a reading section that has a shape extending along a first axis and is configured to read the document placed at the platen by moving along a second axis crossing the first axis;
a drive unit including a motor that is a power source for moving the reading section and a driving pulley driven by the motor;
a plurality of driven pulleys configured to be driven to rotate;
an endless belt wound around the driving pulley and the plurality of driven pulleys and configured to pull the reading section in accordance with rotation of the motor;
a case configured to constitute a base body of the apparatus and including a housing recess configured to house the drive unit; and
a flexible flat cable curved to form a turn-around region between a first holding region provided to the case and a second holding region provided to the reading section, wherein the plurality of driven pulleys includes a first driven pulley, a second driven pulley, and a third driven pulley,
a straight line connecting a center of a rotary shaft of the first driven pulley and a center of a rotary shaft of the second driven pulley extends along the first axis,
one direction of directions along the first axis is defined as a first direction, an opposite direction to the first direction is defined as a second direction, one direction of directions along the second axis is defined as a third direction, an opposite direction to the third direction is defined as a fourth direction,
the second driven pulley is located at the third direction side with respect to the first driven pulley from a viewpoint of the second axis,
the third driven pulley is located at the first direction side with respect to the second driven pulley from a viewpoint of the first axis and is located at the fourth direction side with respect to the second driven pulley from the viewpoint of the second axis, and
the drive unit is located at the first direction side with respect to the third driven pulley from the viewpoint of the first axis,
the driving pulley is located at the fourth direction side with respect to the second driven pulley from the viewpoint of the second axis,
at least a part of the drive unit is located at a position overlapping the reading section when viewed from a normal direction with respect to the platen when the reading section is located at an end portion in the third direction in a movement area,
a section of the endless belt between the first driven pulley and the third driven pulley is defined as a first belt section,
the first holding region, the second holding region, and the flexible flat cable are located at the first direction side with respect to the first belt section from the viewpoint of the first axis, and
the turn-around region of the flexible flat cable is closest to the reading section when the reading section is located at an end portion in the third direction in the movement area, and
the flexible flat cable and the drive unit overlap each other when viewed from the normal direction when the reading section is located in the end portion in the third direction in the movement area, and the overlap between the flexible flat cable and the drive unit is eliminated by the reading section moving in the fourth direction from the end portion in the third direction in the movement area.

2. The image reading apparatus according to claim 1, wherein
a section between the third driven pulley and the driving pulley is defined as a second belt section, a section between the driving pulley and the second driven pulley is defined as a third belt section, and a section between the second driven pulley and the first driven pulley is defined as a fourth belt section,
the first belt section extends along the second axis, and
when the reading section is located at the end portion in the third direction of the movement area, an entire area of the second belt section overlaps the reading section when viewed from the normal direction.

3. The image reading apparatus according to claim 2, wherein
a part of the flexible flat cable and a part of the third belt section overlap each other viewed from the normal direction when the reading section is located at the end portion in the third direction in the movement area.

4. The image reading apparatus according to claim 2, wherein
when the reading section is located at the end portion in the third direction in the movement area, a part of the driving pulley and a part of the reading section overlap each other when viewed from the normal direction, and
the reading section is provided with a clearance portion configured to avoid the driving pulley or a fixing member configured to fix the driving pulley when the reading section is located at the end portion in the third direction in the movement area.

5. The image reading apparatus according to claim 1, wherein
an upper portion of the housing recess is opened to expose the drive unit.

6. The image reading apparatus according to claim 1, wherein
the reading section includes a pressing member configured to apply tension to the endless belt.

7. A recording apparatus comprising:
a recording unit including a recording section configured to perform recording on a medium; and
the image reading apparatus according to claim 1 that is rotatably coupled to the recording unit and rotates to thereby be switchable between a closed state in which an upper portion of the recording unit is covered and an open state in which the upper portion of the recording unit is opened.

8. The recording apparatus according to claim 7, wherein
the recording unit includes
a medium support section configured to support the medium to be fed in an inclined posture,
a feed roller configured to feed the medium from the medium support section, and
a frame that is located between the medium support section and the recording section, and includes a first frame surface facing the feed roller, and a second frame surface that is opposite to the first frame surface and faces the recording section,
the case includes a protruding region that is a region forming the housing recess and protrudes downward from the case, and
in the closed state of the image reading apparatus, the protruding region is located at a lateral side of the medium support section in a width direction crossing a feeding direction of the medium from the medium support section, and at least a part of the protruding region is located vertically below an upper end portion of the frame.

9. The recording apparatus according to claim 8, wherein
the recording unit includes
a carriage configured to move in the width direction,
a recording head mounted on the carriage, and
a maintenance unit that is disposed outside a medium conveyance area and in an end portion at one side in a movable area of the carriage in the width direction and is configured to perform maintenance on the recording head, and
at least a part of the maintenance unit and at least a part of the protruding region overlap each other in the width direction.
